(19) United States
(12) Patent Application Publication
(10) Pub. No.: US 2013/0146530 A1
(43) Pub. Date: Jun. 13, 2013

(54) MEMBRANE, WATER TREATMENT SYSTEM, AND METHOD OF MAKING

(71) Applicants: Hua Wang, Clifton Park, NY (US); Steven Thomas Rice, Scotia, NY (US); Gary William Yeager, Rexford, NY (US); Joseph Anthony Suriano, Clifton Park, NY (US); Elizabeth Marie Dees, Ballston Lake, NY (US)

(72) Inventors: Hua Wang, Clifton Park, NY (US); Steven Thomas Rice, Scotia, NY (US); Gary William Yeager, Rexford, NY (US); Joseph Anthony Suriano, Clifton Park, NY (US); Elizabeth Marie Dees, Ballston Lake, NY (US)

(73) Assignee: GENERAL ELECTRIC COMPANY, SCHENECTADY, NY (US)

(21) Appl. No.: 13/314,921

(22) Filed: Dec. 8, 2011

(51) Int. Cl. B01D 71/54; B05D 5/00; B01D 71/06; B01D 71/40; B82Y 30/00

(52) U.S. Cl. 210/500.38; 210/500.27; 210/500.37; 427/244; 977/773; 977/755

(57) ABSTRACT

One aspect of the present invention includes a membrane. The membrane includes a porous support and a polymeric layer disposed on the porous support. The membrane further includes a plurality of substantially hydrophobic mesoporous nanoparticles disposed within the polymeric layer. A water treatment system and a method of making a membrane are also presented.

### BACKGROUND

The invention generally relates to a membrane, a water treatment system including the membrane and a method of making the membrane. More particularly, the invention relates to a thin film composite membrane including substantially hydrophobic mesoporous nanoparticles.

Reverse osmosis (RO) or nanofiltration (NF) desalination processes use membrane technology to transform seawater and brackish water into fresh water for drinking, irrigation and industrial applications. RO and NF desalination processes require substantially less energy than thermal desalination.

Composite RO and NF membranes typically include a thin dense membrane (about 100-500 nm thick) disposed onto a fiber-supported ultrafiltration membrane. This thin dense film, responsible for rejection of hydrated ions, is typically prepared by interfacial polymerization of electrophilic and nucleophilic monomers such as monomeric polyamines with poly(acyl halides). The monomers for a specific RO or NF application are usually chosen so as to give an optimal balance of salt rejection and hydraulic permeability. NF membranes are typically characterized by salt rejections of 95%-97% salt rejection whereas RO membranes are typically characterized by 99.0-99.75% salt rejection. Despite their high salt rejection, RO and NF membranes are limited by low hydraulic permeabilities. Increased hydraulic permeability may reduce the energy costs associated with operation of RO and NF desalination processes.

Thus, there is a need for RO and NF membranes that maintain high salt rejection with increased hydraulic permeability. Further, there is a need for improved methods of making membranes having increased hydraulic permeability without decreasing their salt rejection entitlement.

### BRIEF DESCRIPTION OF THE INVENTION

Embodiments of the present invention are provided to meet these and other needs. One embodiment is a membrane. The membrane includes a porous support and a polymeric layer disposed on the porous support. The membrane further includes a plurality of substantially hydrophobic mesoporous nanoparticles disposed within the polymeric layer.

One embodiment is a water treatment system. The water treatment system includes a filtration unit including a membrane. The membrane includes a porous support and a polymeric layer disposed on the porous support. The membrane further includes a plurality of substantially hydrophobic mesoporous nanoparticles disposed within the polymeric layer. The water treatment system further includes a flow inducing mechanism configured to provide a flow of an aqueous solution including a chemical species to the membrane, and wherein the membrane is configured to separate a portion of chemical species from the aqueous solution.

One embodiment is a method of making a membrane. The method includes contacting an organic solution including a first monomer with an aqueous solution including a second monomer to form a polymeric layer disposed on a porous support, wherein at least one of the organic solution or the aqueous solution further includes substantially hydrophobic mesoporous nanoparticles.

### DRAWINGS

These and other features, aspects, and advantages of the present invention will become better understood when the following detailed description is read with reference to the accompanying drawings, wherein:

FIG. 1 illustrates a schematic of a membrane, in accordance with one embodiment of the invention.

FIG. 2 illustrates a schematic of a water treatment system, in accordance with one embodiment of the invention.

### DETAILED DESCRIPTION

As discussed in detail below, some of the embodiments of the invention include a membrane, a water treatment system including the membrane, and a method of making the membrane. More particularly, the invention relates to a thin film composite membrane including substantially hydrophobic mesoporous nanoparticles.

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In some instances, the approximating language may correspond to the precision of an instrument for measuring the value.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

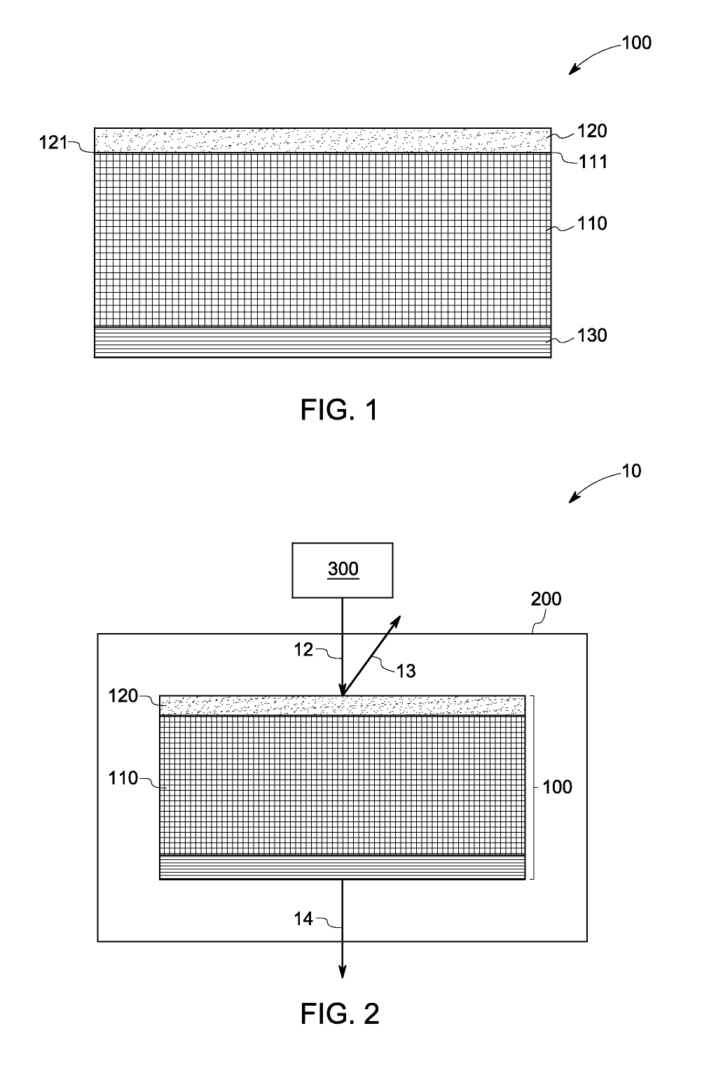

One embodiment includes a membrane. As indicated in FIG. 1, the membrane 100 includes a porous support 110 and a polymeric layer 120 disposed on the porous support 110. The membrane 100 further includes a plurality of substantially hydrophobic mesoporous nanoparticles disposed within the polymeric layer 120.

In some embodiments, the porous support 110 provides mechanical or structural support to the membrane 100 and the polymeric layer 120 functions as a selectively permeable membrane. The term “selectively permeable membrane” as used herein means that the layer allows for selective passage of certain molecules or ions and does not allow for passage of other molecules or ions. The rate of passage may depend in part on the pressure, concentration, and temperature of the molecules or ions on either side of the membrane, as well as the permeability of the membrane to each molecule or ions. Permeability of the selectively permeable membrane may depend, in part, on one or more of the size, solubility, or chemistry of the molecules or ions present in the solution.

The term “disposed on” as used in this context means that the polymeric layer is either disposed on a first surface 111 of the porous support 110 (as indicated in FIG. 1) or is partially impregnated inside the pores of the porous support 110. In some embodiments, as described later, the polymeric layer 120 is formed by interfacial polymerization on the first surface 111 of the porous support or partially within the pores of the porous support 110. Thus, in some embodiments, as indicated in FIG. 1, a first surface 121 of the polymeric layer 120 is disposed contiguous to the first surface 111 of the porous support 110. In some other embodiments, a portion of the polymeric layer is impregnated inside the pores of the porous support 110 (not shown).

In some embodiments, the polymeric layer 120 includes a material formed by interfacial polymerization of a first monomer and a second monomer. The term “interfacial polymerization” as used herein refers to a polymerization reaction that occurs at or near the interfacial boundary of two immiscible solutions. In some embodiments, as described later, the first monomer is present in an organic solution and the second monomer is present in an aqueous solution, and the polymeric layer is formed by interfacial polymerization at the interface of the aqueous solution and the organic solution.

In some embodiments, the polymeric layer 120 includes a polymeric material capable of being formed by interfacial polymerization reaction. In some embodiments, the polymer layer includes a non-crosslinked polymeric material. In alternate embodiments, the polymer layer includes a crosslinked polymeric material. In some embodiments, the polymeric layer 120 includes a polyamide, a polysulfonamide, a polyurethane, a polyurea, a polyesteramide, polycarbonate, poly(amide-carbonate), or combinations thereof. In particular embodiments, the polymeric layer 120 includes a polyamide, a polyurea, or combinations thereof. In particular embodiments, the polymeric layer 120 includes a cross-linked polyamide, a cross-linked polyurea, or combinations thereof.

As noted earlier, in certain embodiments, the polymeric layer 120 includes structural units derived from a first monomer and a second monomer. In some embodiments, the first monomer includes an acid halide, an isocyanate, or combinations thereof. The term “acid halide” as used herein refers to derivatives of acids in which the hydroxy groups of the acid moiety are replaced by the halide groups. In some embodiments, the term “acid halide” includes derivatives of carboxylic acid, sulfonic acid, phosphonic acid, or combinations thereof. In certain embodiments, the acid halide includes an acyl halide, a sulfonyl halide, a chloroformate, a carboxylic acid chloride, or combinations thereof.

In some embodiments, suitable examples of first monomer include, but are not limited to, acid halide-terminated polyamide oligomers (e.g. copolymers of piperazine with an excess of isophthaloyl chloride); benzene dicarboxylic acid halides (e.g. isophthaloyl chloride or terephthaloyl chloride); benzene tricarboxylic acid halides (e.g. trimesoyl chloride or trimellitic acid trichloride); cyclohexane dicarboxylic acid halides (e.g. 1,3-cyclohexane dicarboxylic acid chloride or 1,4-cyclohexane dicarboxylic acid chloride); cyclohexane tricarboxylic acid halides (e.g. cis-1,3,5-cyclohexane tricarboxylic acid trichloride); pyridine dicarboxylic acid halides (e.g. quinolinic acid dichloride or dipicolinic acid dichloride); trimellitic anhydride acid halides; benzene tetra carboxylic acid halides (e.g. pyromellitic acid tetrachloride); pyromellitic acid dianhydride; pyridine tricarboxylic acid halides; sebacic acid halides; azelaic acid halides; adipic acid halides; dodecanedioic acid halides; toluene diisocyanate; methylenebis(phenyl isocyanates); naphthalene diisocyanates; bitolyl diisocyanates; hexamethylene diisocyanate; phenylene diisocyanates; isocyanato benzene dicarboxylic acid halides (e.g. 5-isocyanato isophthaloyl chloride); haloformyloxy benzene dicarboxylic acid halides (e.g. 5-chloroformyloxy isophthaloyl chloride); dihalosulfonyl benzenes (e.g. 1,3-benzenedisulfonic acid chloride); halosulfonyl benzene dicarboxylic acid halides (e.g. 3-chlorosulfonyl isophthaloyl chloride); 1,3,6-tri(chlorosulfonyl)naphthalene; 1,3,7 tri(chlorosulfonyl)napthalene; trihalosulfonyl benzenes (e.g. 1,3,5-trichlorosulfonyl benzene); and cyclopentanetetracarboxylic acid halides, or combinations thereof.

In certain embodiments, suitable examples of first monomer include, but are not limited to, terephthaloyl chloride, isophthaloyl chloride, 5-isocyanato isophthaloyl chloride, 5-chloroformyloxy isophthaloyl chloride, 5-chlorosulfonyl isophthaloyl chloride, 1,3,6-(trichlorosulfonyl)naphthalene, 1,3,7-(trichlorosulfonyl)napthalene, 1,3,5-trichlorosulfonyl benzene, or combinations thereof. In particular embodiments, the first monomer includes trimesoyl chloride.

In some embodiments, the second monomer includes an amine. In some embodiments, suitable examples of second monomer include, but are not limited to, amine containing monomers such as polyethylenimines; cyclohexanediamines; 1,2-diaminocyclohexane; 1,4-diaminocyclohexane; piperazine; methyl piperazine; dimethylpiperazine (e.g. 2,5-dimethyl piperazine); homopiperazine; 1,3-bis(piperidyl)propane; 4-aminomethylpiperazine; cyclohexanetriamines (e.g. 1,3,5-triaminocyclohexane); xylylenediamines (o-, m-, p-xylenediamine); phenylenediamines; (e.g. m-phenylenediamine and p-phenylenediamine, 3,5-diaminobenzoic acid, 3,5-diaminosulfonic acid); chlorophenylenediamines (e.g. 4- or 5-chloro-m-phenylenediamine); benzenetriamines (e.g. 1,3,5-benzenetriamine, 1,2,4-triaminobenzene); bis(aminobenzyl)aniline; tetraaminobenzenes; diaminobiphenyls (e.g. 4,4,′-diaminobiphenyl; tetrakis(aminomethyl)methane; diaminodiphenylmethanes; N,N′-diphenylethylenediamine; aminobenzaminildes (e.g. 4-aminobenzanilide, 3,3′-diaminobenzanilide; 3,5-diaminobenzanilide; 3,5-diaminobenzanilide; 3,3′5,5′-tetraaminobenzanilide); or combinations thereof.

In certain embodiments, suitable examples of second monomer include, but are not limited to, m-phenylenediamine, p-phenylenediamine, 1,3,5-triaminobenzene, piperazine, 4-aminomethylpiperidine, or combinations thereof. In particular embodiments, the second monomer includes m-phenylenediamine.

As noted earlier, the polymeric layer 120 may be formed on the first surface 111 of the porous support 110 or alternately may be impregnated partially inside the pores of the porous support 110. In some embodiments, the polymeric layer 120 has a thickness (including the thickness if disposed inside the pores of the porous support) in a range from about 10 nanometers to about 1000 nanometers. In some embodiments, the polymeric layer 120 has a thickness in a range from about 10 nanometers to about 500 nanometers.

As noted earlier, the membrane 100 further includes a plurality of substantially hydrophobic mesoporous nanoparticles disposed within the polymeric layer 120. The term “nanoparticles” as used herein refers to particles having an average dimension (for example, a diameter or length) in the range of from about 1 nanometer to 1000 nanometers. “Nanoparticle” as used herein may refer to a single nanoparticle, a plurality of nanoparticles, or a plurality of nanoparticles associated with each other. “Associated” refers to a nanoparticle in contact with at least one other nanoparticle. In one embodiment, associated refers to a nanoparticle in contact with more than one other particle.

The plurality of particles may be characterized by one or more of median particle size, particle size distribution, median particle surface area, particle shape, particle cross-sectional geometry, or particle pore size. In some embodiments, an average particle size of the plurality of nanoparticles may be in a range from about 1 nanometer to about 1000 nanometers. In some embodiments, an average particle size of the plurality of nanoparticles may be in a range from about 1 nanometer to about 500 nanometers. In some embodiments, an average particle size of the plurality of nanoparticles may be in a range from about 10 nanometers to about 200 nanometers. In some embodiments, the nanoparticle may include a plurality of particles having a particle size distribution selected from the group consisting of normal distribution, unimodal distribution, and bimodal distribution.

A nanoparticle may have a variety of shapes and cross-sectional geometries. In some embodiments, a nanoparticle may have a shape that is a sphere, a flake, a plate, a cube, or a whisker. A nanoparticle may include particles having two or more of the aforementioned shapes. In some embodiments, a cross-sectional geometry of the particle may be one or more of circular, ellipsoidal, triangular, rectangular, or polygonal. In some embodiments, the nanoparticles may be irregular in shape. In some embodiments, the nanoparticle may include spherical particles.

The plurality of nanoparticles may be further characterized by the pore size. The term “mesoporous” as used herein means that the plurality of nanoparticles includes pores having a median pore size in a range from about 2 nanometers to about 50 nanometers. In some embodiments, the plurality of nanoparticles include a plurality of pores having a median pore size in a range from about 2 nanometers to about 20 nanometers.

The plurality of nanoparticles may be further characterized by their physical response to water. As noted earlier, the membrane 100 includes a plurality of substantially hydrophobic mesoporous nanoparticles. The term “substantially hydrophobic” as used herein means that a film comprised substantially of the plurality of substantially hydrophobic nanoparticles has a water contact angle greater than about 35°. In some embodiments, a film comprised substantially of the plurality of substantially hydrophobic nanoparticles has a water contact angle greater than about 90°. In some embodiments, one or both of a surface of the nanoparticles and a surface of the pores in the nanoparticles may be substantially hydrophobic. In some embodiments, the substantially hydrophobic nanoparticles may include one or more suitable functional groups that render the nanoparticles substantially hydrophobic. In some embodiments, one or more suitable substantially hydrophobic functional groups may be present on a surface of the plurality of nanoparticles. In some embodiments, one or more suitable substantially hydrophobic functional groups may be present on a surface of the pores in the plurality of nanoparticles.

In some embodiments, the substantially hydrophobic mesoporous nanoparticles include substantially hydrophobic carbon nanoparticles. In particular embodiments, the substantially hydrophobic carbon nanoparticles include substantially hydrophobic carbon black nanoparticles. In some embodiments, the polymeric layer 120 is substantially free of carbon nanotubes, carbon nanofibers, or buckyballs. The term “substantially free” as used in this context means that amount of carbon nanotubes, carbon nanofibers, or buckyballs in the polymeric layer 120 is less than about 0.1 weight percent. Suitable substantially hydrophobic mesoporous carbon nanoparticles may be commercially available or may be synthesized using known procedures.

In certain embodiments, substantially hydrophobic mesoporous nanoparticles include carbon nanoparticles functionalized with hydrophobic functional groups. In some embodiments, the substantially hydrophobic carbon nanoparticles include benzene functional groups, graphite functional groups, or combinations thereof. In some embodiments, the substantially hydrophobic carbon nanoparticles include hydrocarbon functional groups. In particular embodiments, the substantially hydrophobic carbon nanoparticles include graphitized carbon black nanoparticles.

In certain embodiments, the substantially hydrophobic mesoporous nanoparticles may be further characterized by carbon to oxygen ratio of the nanoparticles. The term “carbon to oxygen” ratio as used herein refers to a ratio of elemental carbon to elemental oxygen on one or both of a surface of the nanoparticles and a surface of the pores of the nanoparticles. In some embodiments, a carbon to oxygen ratio of the plurality of nanoparticles is greater than about 3. In some embodiments, a carbon to oxygen ratio of the plurality of nanoparticles is greater than about 6. In some embodiments, a carbon to oxygen ratio of the plurality of nanoparticles is greater than about 8. In some embodiments, a carbon to oxygen ratio on a surface of the plurality of nanoparticles is greater than about 3. In some embodiments, a carbon to oxygen ratio on a surface of the pores of the plurality of nanoparticles is greater than about 3.

In some embodiments, the substantially hydrophobic mesoporous nanoparticles include substantially hydrophobic silica nanoparticles. In some embodiments, substantially hydrophobic mesoporous nanoparticles include silica nanoparticles functionalized with hydrophobic functional groups. In some embodiments, the substantially hydrophobic silica nanoparticles include alkyl functional groups, poly dimethyl siloxane functional groups, or combinations thereof. In some embodiments, the substantially hydrophobic silica nanoparticles are substantially free of silsesquioxanes. The term “substantially free” as used in this context means that amount of silsesquioxanes in the polymeric layer 120 is less than about 0.1 weight percent.

In some embodiments, the substantially hydrophobic mesoporous nanoparticles are present in the polymeric layer at a concentration in a range from about 1 weight percent to about 50 weight percent. In some embodiments, the substantially hydrophobic mesoporous nanoparticles are present in the polymeric layer at a concentration in a range from about 2 weight percent to about 40 weight percent.

As noted earlier, in some embodiments, the porous support 110 provides mechanical or structural support to the membrane 110. In some embodiments, the porous support 110 may be further characterized by one or more of the support material, the pore size, or thickness of the porous support.

In some embodiments, the porous support 110 includes a porous material such as, for example, polymer, ceramic, glass, or metal. In some embodiments, the porous support 110 includes a fibrous material. In some embodiments, the porous support 110 includes a polymeric material. In some embodiments, non-limiting examples of polymeric material forming the porous support 100 include polysulfone, polyether sulfone, polyacrylonitrile, cellulose ester, polypropylene, polyvinyl chloride, polyvinylidene fluoride, and poly(arylether) ketones. In some embodiments, the porous support 110 includes a polysulfone, a polyether sulfone, or combinations thereof.

In some embodiments, the porous support 110 includes a plurality of pores of adequate size and density such that the interfacial polymerization of first and second monomers on the surface of 110 disposes a dense film across the surface of the porous support 110. In some further embodiments, the porous support 110 includes a plurality of pores having a median pore size in a range such the polymeric layer 120 is capable of being formed by forming bridges across the surface pores of the porous support 110 and the polymeric material of the polymeric layer 120 does not fill up the pores of the porous support 110. In some embodiments, the porous support 110 includes a porous material having a median pore size in a range from about 50 Angstroms to about 5000 Angstroms.

In some embodiments, the porous support 110 has a thickness in a range from 50 microns to about 5 centimeters. In some embodiments, the porous support 110 has a thickness in a range from 75 microns to about 2.5 centimeters. In some embodiments, the porous support 110 has a thickness in a range from 500 microns to about 1 centimeter. In some embodiments, a thicker porous support 110 may allow for higher flux of fluid across the membrane 100. In some embodiments, the porous support 100 may be reinforced by backing layer 130 using a fabric or a non-woven web material, as indicated in FIG. 1. Non-limiting examples of backing material include films, sheets, and nets, such as, a nonwoven polyester cloth.

One embodiment includes a method of making a membrane. In one embodiment, the method includes contacting an organic solution including a first monomer with an aqueous solution including a second monomer to form a polymeric layer 120 disposed on a porous support 110, as indicated in FIG. 1. In certain embodiments, the method includes forming the polymeric layer 120 by interfacial polymerization reaction on a surface 111 of the porous support 110 or partially within the pores of the porous support 110.

In some embodiments, the method includes contacting at least a portion of the porous support 110 with the organic solution or the aqueous solution such that a portion of the porous support 110 is treated with either the organic solution or the aqueous solution. In some embodiments, the method further includes contacting the treated porous support with either the aqueous solution or the organic solution depending on the solution the porous support was treated with earlier. Thus, by way of example, in some embodiments, the porous support 110 may be first contacted with an organic solution including the first monomer and the treated porous support may be later contacted with an aqueous solution including the second monomer to effect interfacial polymerization between the first monomer and the second monomer and form the polymeric layer 120

In particular embodiments, the method includes contacting a portion of the porous support 110 with an aqueous solution including the second monomer to form a treated porous support. In some embodiments, the method further includes contacting an organic solution including the first monomer with the treated porous support to effect interfacial polymerization between the first monomer and the second monomer and form the polymeric layer 120. In some embodiments, the aqueous solution or the organic solution may be contacted with the porous support 110 or the treated porous support using a coating method, pouring method, a soaking method, or combinations thereof. In some embodiments, suitable coating methods include dip coating, spray coating, slot die coating, or combinations thereof.

In some embodiments, the organic solution includes an organic solvent and a first monomer. In some embodiments, suitable organic solvents include aliphatic hydrocarbons, alcohols, ketones, esters, ethers, amides, and mixtures thereof. In particular embodiments, aliphatic hydrocarbons such as decalins, isoparaffins, and mixtures thereof may be used.

In some embodiments, the organic solvent includes a sulfoxide or a sulfone such as dimethylsulfoxide, tetramethylene sulfoxide, tetramethylene sulfone, butyl sulfoxide, or butyl sulfone. In some embodiments, the organic solvent includes a nitrile such as propiononitrile or acetonitrile. In some embodiments, the organic solvent includes an amide or urea derivative such as N,N-dimethylacetamide, butyrolactam, N-methylpyrolidinone, or 1,3-dimethyl-2-methylimidazolidinone.

In some embodiments, the organic solution may further include a cyclic C₅-C₂₀ alcohol, polyol, or ether derivative therefrom. In some embodiments the C₅-C₂₀ alcohol, polyols, or ether derivative includes 2-methoxyethanol, 2-ethoxyethanol, 2-butoxyethanol, di(ethylene glycol), t-butylmethylether, diethylene glycol hexyl ether, propylene glycol butyl ether, propylene glycol propyl ether, 1,3-heptanediol butyl ether, 1,3-heptanediol propyl ether.

In some embodiments, the organic solution may further include a cyclic C₅-C₂₀ ketone solvent. In some embodiments, the organic solution further includes a cyclic ketone such as cyclooctanone, cycloheptanone, 2 methylcyclohexanone, cyclohexanone, cyclohexene-3-one, cyclopentanone, cyclobutanone, 3-tetrahydrofuran-3-one, 3-tetrahydrothiophen-3-one, or oxetan-3-one

In other embodiments the organic solution may further include a C₃-C₈ cyclic ester, for example, 2-methylcaprolactone, caprolactone, valerolactone, butyrolactone, diketene, propionolactone. In some embodiments, the organic solution may further include a C₃-C₈ cyclic carbonate, for example, ethylene carbonate, propylene carbonate, 1,2-butanediolcarbonate, 1,2-pentanediol carbonate, 1,2-hexanediol carbonate, or 1,2-heptanediol carbonate. In particular embodiments, the organic solution further includes cyclohexanone.

As noted earlier, in some embodiments, the first monomer includes an acid halide, an isocyanate or combinations thereof. Suitable examples of first monomer are as described earlier. In certain embodiments, the first monomer includes an acid halide, such as, for example, trimesoyl chloride.

In some embodiments, the aqueous solution includes water or a polar solvent and a second monomer. In some embodiments, the aqueous solution may further include dispersing aids, such as, polyvinylpyrrolidone, or surfactants, such as, non-ionic surfactants. As noted earlier, in some embodiments, the second monomer includes an amine. Suitable examples of second monomer are as described earlier. In certain embodiments, the second monomer includes phenylenediamine. In some embodiments, one or both of the aqueous solution and the organic solution may further include additives, such as, for example, crosslinking agents, polymerization catalysts, or combinations thereof.

In certain methods according to the present invention, one or both of the organic solution and the aqueous solution further include substantially hydrophobic mesoporous nanoparticles dispersed therein. In some embodiments, the substantially hydrocarbon mesoporous nanoparticles are present in the organic solution or the aqueous solution at a concentration in a range from about 0.05 weight percent to about 10 weight percent of the solution. In some embodiments, the substantially hydrocarbon mesoporous nanoparticles are present in the organic solution or the aqueous solution at a concentration in a range from about 0.1 weight percent to about 5 weight percent of the solution. In some embodiments, the method further includes the step of dispersing the substantially hydrophobic mesoporous nanoparticles in the aqueous solution or the organic solution. In some embodiments, suitable methods of dispersing the nanoparticles in the aqueous solution or the organic solution include ultrasonication, mechanical stirring, sol-gel method, or combinations thereof.

In particular embodiments, the organic solution includes the substantially hydrophobic mesoporous nanoparticles and the aqueous solution is substantially free of the substantially hydrophobic mesoporous nanoparticles. The term “substantially free” as used in this context means that an amount of substantially hydrophobic mesoporous nanoparticles in the aqueous solution is less than about 0.1 weight percent. In some embodiments, the mesoporous hydrocarbon nanoparticles are present in the organic solution at a concentration in a range from about 0.05 weight percent to about 5 weight percent of the organic solution. Suitable examples of substantially hydrophobic mesoporous nanoparticles are as described earlier.

In some embodiments, the method further includes heating one or more of the porous support, the aqueous solution, the organic solution, and the treated porous support prior to or during the interfacial polymerization reaction. In some embodiments, the interfacial polymerization reaction may be carried out at a temperature in a range from about 5° C. to about 60° C. In some embodiments, the method includes forming a membrane 100 by disposing the polymeric layer 120 on the porous support 110. In some embodiments, the method may further include the step of cross-linking the polymer in the polymeric layer 120.

In some embodiments, the membrane 100 may be further subjected to one or most post-treatment steps, such as, for example, removal of unreacted monomers, cross-linking, oxidizing, or combinations thereof. In some embodiments, to improve one or both of permeability and salt rejection of the membrane 100, the membrane 100 may be post-treated with an oxidizing solution, such as a sodium hypochlorite solution. The concentration of sodium hypochlorite in the solution may range from about 50 ppm to about 4000 ppm, in some embodiments.

In some embodiments, the membrane 100 of the present invention includes a thin film composite membrane. The term “thin film composite membrane” as used herein refers to a membrane including a thin barrier layer supported on a porous substrate. The term “thin” as used herein means that a thickness of the barrier layer is less than about 500 nanometers. In some embodiments, the polymeric layer 120 functions as the barrier layer in the thin film composite membrane 100 and the porous support 110 functions as a porous substrate.

In some embodiments, the membranes of the present invention may be used in separation or filtration systems. In some embodiments, the membrane 100 may be used to purify a liquid by removing impurities dissolved, suspended, or dispersed within the liquid as it is passed through the membrane. In some further embodiments, the membrane 100 may be used to concentrate impurities by retaining the impurities dissolved, suspended, or dispersed within a liquid as the liquid is passed through the membrane.

In some embodiments, the membrane 100 may be suitable for one or more of seawater desalination, brackish water desalination, surface and ground water purification, cooling tower water hardness removal, drinking water softening, and ultra-pure water production. In some embodiments, the membrane 100 may be suitable for separation or purification of liquids other than water. For example, in some embodiments, the membrane 100 may be used to remove impurities from alcohols, including methanol, ethanol, n-propanol, isopropanol, or butanol.

In some embodiments, the membrane 100 of the present invention may be suitable in reverse osmosis membrane applications or nanofiltration membrane applications. One embodiment includes a reverse osmosis filtration unit 200 including the membrane 100, as indicated in FIG. 2. One embodiment includes a nanofiltration unit 200 including the membrane 100, as indicated in FIG. 2.

One embodiment includes a water treatment system. As indicated in FIG. 2, in some embodiments, the water treatment system 10 includes a filtration unit 200. The filtration unit 200 includes a membrane 100 including a porous support 110 and a polymeric layer 120 disposed on the porous support 110, as described earlier. The polymer layer 120 further includes a plurality of substantially hydrophobic mesoporous nanoparticles disposed therein. The water treatment system 10 further includes a flow inducing mechanism 300. As noted earlier, in some embodiments, the filtration unit 200 includes a reverse osmosis filtration unit. In some embodiments, the filtration unit 200 includes a nanofiltration unit.

The flow inducing mechanism 300 is configured to provide a flow of an aqueous solution 12 including a chemical species to the membrane 110, wherein the membrane 100 is configured to separate a portion of chemical species 13 from the aqueous solution 12, as indicated in FIG. 2. In some embodiments, the flow inducing mechanism includes a pump. In some embodiments, the flow inducing mechanism includes a pump configured to operate at a pressure greater than about 1 MPa. In one embodiment, a flow inducing mechanism 300 includes a positive displacement pump. Suitable non-limiting examples of positive displacements pumps as flow inducing mechanism include a rotary-type positive displacement pump, a reciprocating-type positive displacement pump, and a linear-type positive displacement pump. Further, suitable examples of positive displacement pumps include, but are not limited to rotary lobe pump, progressive cavity pump, rotary gear pump, piston pump, diaphragm pump, screw pump, gear pump, hydraulic pump, vane pump, regenerative (peripheral) pump, peristaltic pump, and rope pump. In one embodiment, a flow inducing mechanism 300 includes a centrifugal pump. Suitable examples of positive displacements pumps as flow inducing mechanism include a radial flow pump, and axial flow pump, and a mixed flow pump.

In some embodiments, the membrane 100 is further configured to allow passage of the treated aqueous solution 14, wherein a concentration of chemical species in the treated aqueous solution 14 is lower than the concentration of chemical species in the aqueous solution 12 before treatment.

In some embodiments, the membrane 100 is configured to separate at least about 95 percent of the chemical species in the aqueous solution 12. In some embodiments, the membrane 100 is configured to separate at least about 99 percent of the chemical species in the aqueous solution 12. In some embodiments, the membrane 100 is configured to separate at least about 99.7 percent of the chemical species in the aqueous solution 12.

### EXAMPLES

### Example 1

### General Procedure for Membrane Fabrication and Testing

Membrane fabrication using handframe coating apparatus: Composite membranes were prepared using a handframe coating apparatus including a matched pair of frames in which the porous base support could be fixed and subsequently coated with the coating solution. The porous base support was first soaked in deionized water for at least 30 minutes. The wet porous base support was fixed between two 8 inches by 11 inches stainless steel frames and kept covered with water until further processed. Excess water was removed from the porous base support and one surface of the porous base support was treated with 200 grams of an aqueous solution including meta-phenylenediamine (2.6% by weight), triethylamine salt of camphorsulfonic acid (TEACSA) (6.6% by weight), the upper portion of the frame confining the aqueous solution to the surface of the porous base support. After 30 seconds, the aqueous solution was removed from the surface of the porous base support. The treated surface was then exposed to a gentle stream of air to remove isolated drops of the aqueous solution. The treated surface of the porous base support was then contacted with 100 grams of an organic solution containing trimesoyl chloride (0.16% by weight) and nanoparticles (type and concentration of nanoparticles provided below) in ISOPAR™ G solvent. Prior to application of the organic solution, the organic solution containing nanoparticles was first sonicated using a bath sonicator for 60 minutes and then allowed to stand for 20 minutes. Excess organic solution was then removed. The frame was then returned to a horizontal position and the remaining film of organic solution on the treated surface of the porous base support was allowed to stand for about 1 minute. The remaining organic solution was drained from the treated surface of the porous base support with the aid of a gentle air stream. The treated assembly was then placed in a drying oven and maintained at a temperature of 90° C. for about 6 minutes after which the composite membrane was ready for testing.

Membrane performance testing: Membrane tests were carried out on composite membranes configured as a flat sheet in a cross-flow test cell apparatus (Sterlitech Corp., Kent Wash.) (model CF042) with an effective membrane area of 35.68 cm². The test cells were plumbed two in series in each of 6 parallel test lines. Each line of cells was equipped with a valve to turn feed flow on/off and regulate concentrate flow rate, which was set to 1 gallon per minute (gpm) in all tests. The test apparatus was equipped with a temperature control system that included a temperature measurement probe, a heat exchanger configured to remove excess heat caused by pumping, and an air-cooled chiller configured to reduce the temperature of the coolant circulated through the heat exchanger.

Composite membranes were first tested with a fluorescent red dye (rhodamine WT from Cole-Parmer) to detect defects. A dye solution including 1% rhodamine red dye was sprayed on the polyamide surface of the composite membrane and allowed to stand for 1 minute, after which time the red dye was rinsed off. Since rhodamine red dye does not stain polyamide, but stains polysulfone strongly, a defect-free membrane should show no dye stain after thorough rinse. On the other hand, dye stain patterns (e.g. red spots or other irregular dye staining patterns) indicate defects in the composite membranes. The membranes were cut into 2 inch×6 inch rectangular coupons, and loaded into cross flow test cells. Three coupons (3 replicates) from each type of membranes were tested under the same conditions and the results obtained were averaged to obtain mean performance values and standard deviations. The membrane coupons were first cleaned by circulating water across the membrane in the test cells for 30 minutes to remove any residual chemicals and dyes. Then, synthetic brackish water containing 500 ppm sodium chloride was circulated across membrane at 115 psi and 25° C. The pH of the water was controlled at pH 7.5. After one hour of operation, permeate samples were collected for 10 minutes and analyzed.

After the initial test period, test coupons were exposed to a 70 ppm aqueous solution of sodium hypochlorite at 25° C. for 30 minutes. The test coupons were then rinsed with deionized water for 1 hour.

Following the “chlorination” procedure, the test coupons were again tested for reverse osmosis membrane performance with the synthetic feed solution containing 500 ppm sodium chloride used before as described herein. Solution conductivities and temperatures were measured with a CON 11 conductivity meter (Oakton Instruments). Conductivities were compensated to measurement at 25° C. The pH was measured with a Russell RL060P portable pH meter (Thermo Electron Corp). Permeate was collected in a graduated cylinder. The permeate was weighed on a Navigator balance and time intervals were recorded with a Fisher Scientific stopwatch. Permeability, or “A value”, of each membrane was determined at standard temperatures (77° F. or 25° C.). Permeability is defined as the rate of flow through the membrane per unit area per unit pressure. A values were calculated from permeate weight, collection time, membrane area, and transmembrane pressure. A values reported herein have units of 10⁻⁵ cm³/s-cm²-atm. Salt concentrations determined from the conductivities of permeate and feed solutions were used to calculate salt rejection values. Conductivities of the permeate and feed solutions were measured, and salt concentrations calculated from the conductivity values, to yield salt rejection values.

### Comparative Example 1

### Polyamide Thin Film Composite Membrane without Nanoparticles

A polyamide thin film composite membrane was fabricated using a handframe coating apparatus as described earlier. An aqueous coating solution (Solution A) containing 2.6 wt % m-phenylene diamine (mPD) and 6.6 wt % triethylammonium camphorsulfonate (TEACSA) and an organic coating solution (Solution B) contained 0.16 wt % trimesoyl chloride (TMC) in ISOPAR™ G were prepared. A wet polysulfone porous support film was first coated with the aqueous solution containing the m-phenylenediamine (Solution A) and then coated with the organic solution including the trimesoyl chloride (Solution B) to effect an interfacial polymerization reaction between the diamine and the triacid chloride at one surface of the polysulfone porous support film, thereby producing a thin film composite membrane (Comparative Sample 1). The product membrane was tested in triplicate using a solution of magnesium sulfate (500 ppm in NaCl) at an applied operating pressure of 115 pounds per square inch (psi) and operating crossflow rate of 1.0 gram per minute (grams per mole), at pH 7.0 as described earlier in Example 1. The permeability and salt passage results pre-chlorination and post-chlorination are shown in Table 2.

### Comparative Example 2

### Polyamide Thin Film Composite Membrane including Hydrophilic Mesostructured Aluminosilicate Nanoparticles

Polyamide thin film composite membranes (Comparative Samples 2a and 2b) were fabricated as in Comparative Example 1 with the exception that the organic coating solution (Solution B) also contained 0.1 wt % hydrophilic mesostructured aluminosilicate particles available from Sigma Aldrich. The composition and structural details of the nanoparticles are provided in Table 1. The product composite membranes were tested and membrane A-values and salt passage properties were measured and are provided in Table 2.

### Comparative Example 3

### Polyamide Thin Film Composite Membrane including Hydrophilic Mesoporous Aluminum Oxide Nanoparticles

Polyamide thin film composite membranes (Comparative Samples 3a and 3b) were fabricated as in Comparative Example 1 with the exception that the organic coating solution (Solution B) also contained 0.1 wt % hydrophilic mesoporous aluminum oxide particles available from Sigma Aldrich. The composition and structural details of the nanoparticles are provided in Table 1. The product composite membranes were tested and membrane A-values and salt passage properties were measured and are provided in Table 2.

### Example 2

### Polyamide Thin Film Composite Membrane including Substantially Hydrophobic Mesoporous Carbon Nanoparticles

Polyamide thin film composite membranes (Samples 1a-1c) were fabricated as in Comparative Example 1 with the exception that the organic coating solution (Solution B) also contained 0.1 wt % substantially hydrophobic mesoporous carbon nanoparticles available from Sigma Aldrich. Further, the Sample 1c was prepared using 50:50 by volume Isopar G and decalin. The composition and structural details of the nanoparticles are provided in Table 1. The product composite membranes were tested and membrane A-values and salt passage properties were measured and are provided in Table 2.

### Example 3

### Polyamide Thin Film Composite Membrane including Substantially Hydrophobic Mesoporous Silica Nanoparticles

Polyamide thin film composite membranes (Samples 2a-2e) were fabricated as in Comparative Example 1 with the exception that the organic coating solution (Solution B) also contained 0.1 wt % substantially hydrophobic mesoporous silica particles available from Claytec Inc. The composition and structural details of the nanoparticles are provided in Table 1. The product composite membranes were tested and membrane A-values and salt passage properties were measured and are provided in Table 2.

TABLE 1
Mesoporous Particles Properties

| | | Particle | Pore | | BET |
|---|---|---|---|---|---|
| | Particle Type and | Diameter | Diameter | Porosity | surface area |
| Sample | Product Number | (nm) | (nm) | (cm³/g) | (cm²/g) |
| Comparative | Aluminosilicate, Al- | | | 2.03 | 605 |
| Sample 2a | MSU-F (cellular foam), | | | | |
| | Aldrich 643629 | | | | |
| Comparative | Aluminosilicate, MCM- | | 2.5-3 | 1.0 | 940-1000 |
| Sample 2b | 41 (hexagonal), | | | | |
| | Aldrich 643629 | | | | |
| Comparative | Al₂O₃, MSU-X | 4400 | 6.5 | 1.0 | 940-1000 |
| Sample 3a | (wormhole) | | | | |
| | Aldrich 517755 | | | | |
| Comparative | Al₂O₃, MSU-X | 5650 | 3.8 | | |
| Sample 3b | (wormhole) | | | | |
| | Aldrich 517747 | | | | |
| Sample 1a | Carbon, (C/O ratio: 8.6), | | 7.0 | 0.4-0.7 | 150-500 |
| | Aldrich 702102 | | | | |
| Sample 1b | Carbon, Aldrich 699632 | <500 | 6.4 | 0.342 | 15-250 |
| Sample 1c | Carbon, Aldrich 699632 | <500 | 6.4 | 0.342 | 15-250 |
| Sample 2a | Silica (SBA-15), | | 2.4 | 0.79-0.92 | 1050 |
| | Claytec Inc. 01-002 | | | | |
| Sample 2b | Silica (HMS-3D | | 2.5 | 0.73-0.76 | 984 |
| | wormhole), | | | | |
| | Claytec Inc. 01-004 | | | | |
| Sample 2c | Silica 3D-wormhole | | 6.5 | 1.2-1.6 | 880 |
| | MSU-JType), | | | | |
| | Claytec Inc. 01-006 | | | | |
| Sample 2d | Silica (3D cubic | | 2.1 | 0.85-1.1 | 1600 |
| | MCM 48 type), | | | | |
| | Claytec Inc. 01-007 | | | | |
| Sample 2e | Silica (MSU-G | | 3.2 | 0.34-0.53 | 412 |
| | 2D Lamella), | | | | |
| | Claytec Inc. 01-009 | | | | |

TABLE 1
Permeance and salt rejection data

| | | Pre-chlorination | | Post-chlorination | | |
|---|---|---|---|---|---|---|
| | | | Passage | | Salt Rejection | Passage |
| Sample | N | A Value | (%) | A Value | (%) | (%) |
| Comparative | 6 | 3.8 | 0.64 | 4.42 | 99.61 | 0.39 |
| Sample 1 | | | | | | |
| Comparative | 3 | 4.73 | 0.23 | 4.73 | 99.85 | 0.15 |
| Sample 2a | | | | | | |
| Comparative | 3 | 3.64 | 0.23 | 3.21 | 99.83 | 0.17 |
| Sample 2b | | | | | | |
| Comparative | 3 | 5.27 | 0.49 | 5.71 | 99.59 | 0.41 |
| Sample 3a | | | | | | |
| Comparative | 3 | 5.06 | 1.05 | 5.62 | 99.37 | 0.63 |
| Sample 3b | | | | | | |
| Sample 1a | 4 | 10.34 | 0.50 | 10.15 | 99.69 | 0.31 |
| Sample 1b | 4 | 8.32 | 0.82 | 8.16 | 99.31 | 0.69 |
| Sample 1c | 4 | 7.20 | 0.89 | 7.07 | 99.45 | 0.55 |
| Sample 2a | 3 | 6.87 | 0.22 | 8.56 | 99.83 | 0.17 |
| Sample 2b | 3 | 5.58 | 0.33 | 5.46 | 99.81 | 0.19 |
| Sample 2c | 3 | 8.50 | 0.24 | 6.90 | 99.84 | 0.16 |
| Sample 2d | 3 | 8.35 | 0.27 | 6.70 | 99.72 | 0.28 |
| Sample 2e | 3 | 7.49 | 0.51 | 7.32 | 99.68 | 0.32 |

The data in Table 2 shows that samples containing substantially hydrophobic mesoporous nanoparticles (Samples 1a-1c and Samples 2a-2e) showed a significant increase in performance relative to the sample without nanoparticles (Comparative Sample 1), samples with hydrophilic aluminosilicate particles (Comparative Samples 2a-2b), and samples with hydrophilic aluminum oxide particles (Comparative Samples 3a-3b)

The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “includes” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A membrane, comprising:
a porous support;
a polymeric layer disposed on the porous support; and
a plurality of substantially hydrophobic mesoporous nanoparticles disposed within the polymeric layer.

2. The membrane of claim 1, wherein the substantially hydrophobic mesoporous nanoparticles comprise substantially hydrophobic carbon, substantially hydrophobic silica, or combinations thereof.

3. The membrane of claim 1, wherein the polymeric layer comprises a polyamide, a polyurea, or combinations thereof.

4. The membrane of claim 3, wherein the polymeric layer comprises a polymer comprising structural units derived from a first monomer and a second monomer, and
wherein the first monomer comprises an acid halide, an isocyanate, or combinations thereof and the second monomer comprises an amine.

5. The membrane of claim 1, wherein the substantially hydrophobic mesoporous nanoparticles have a median diameter in a range from about 1 nanometer to about 500 nanometers.

6. The membrane of claim 1, wherein the substantially hydrophobic mesoporous nanoparticles comprise substantially hydrophobic carbon, and wherein a carbon to oxygen ratio on a surface of the mesoporous nanoparticles is greater than about 3.

7. The membrane of claim 1, wherein the plurality of substantially hydrophobic mesoporous nanoparticles are present in the polymeric layer at a concentration in a range from about 1 weight percent to about 50 weight percent.

8. The membrane of claim 1, wherein the polymeric layer has a thickness in a range from about 10 nanometers to about 500 nanometers.

9. A reverse osmosis filtration unit comprising the membrane of claim 1.

10. A nanofiltration unit comprising the membrane of claim 1.

11. A water treatment system, comprising:
a filtration unit comprising a membrane comprising:
a porous support;
a polymeric layer disposed on the porous support; and
a plurality of substantially hydrophobic mesoporous nanoparticles disposed within the polymeric layer; and
a flow inducing mechanism configured to provide a flow of an aqueous solution comprising a chemical species to the membrane, and wherein the membrane is configured to separate a portion of chemical species from the aqueous solution.

12. A method of making a membrane, comprising:
contacting an organic solution comprising a first monomer with an aqueous solution comprising a second monomer to form a polymeric layer disposed on a porous support,
wherein at least one of the organic solution or the aqueous solution further comprises substantially hydrophobic mesoporous nanoparticles.

13. The method of claim 12, wherein the organic solution comprises the substantially hydrophobic mesoporous nanoparticles and the aqueous solution is substantially free of the substantially hydrophobic mesoporous nanoparticles.

14. The method of claim 12, wherein the first monomer comprises an acid halide, an isocyanate, or combinations thereof and the second monomer comprises an amine

15. The method of claim 12, wherein the first monomer comprises a trimesoyl chloride and the second monomer comprises a phenylene diamine.

16. The method of claim 12, wherein the mesoporous hydrocarbon nanoparticles comprise substantially hydrophobic carbon, substantially hydrophobic silica, or combinations thereof.

17. The method of claim 12, wherein the mesoporous hydrocarbon nanoparticles are present in the organic solution or the aqueous solution at a concentration in a range from about 0.05 weight percent to about 5 weight percent.

18. The method of claim 12, further comprising contacting a portion of the porous support with the aqueous solution to form a treated porous support, and
contacting the organic solution with the treated porous support to form the polymeric layer disposed on the porous support.

19. The method of claim 12, wherein the organic solution further comprises one or more of a cyclic C₅-C₂₀ ketone, a C₃-C₈ cyclic ester, a C₃-C₈ cyclic carbonate, a cyclic C₅-C₂₀ alcohol, a C₅-C₂₀ polyol, or a C₅-C₂₀ ether derivative therefrom.

20. The method of claim 19, wherein the organic solution further comprises cyclohexanone.
